(19) United States
(12) Patent Application Publication
(10) Pub. No.: US 2026/0236807 A1
(43) Pub. Date: Aug. 13, 2026

(54) EXPLAINABLE PREDICTION SYSTEM WITH CATEGORICAL EXPLANATION GENERATION

(71) Applicant: FAIR ISAAC CORPORATION, Minneapolis, MN (US)

(72) Inventors: Gerald Fahner, Minneapolis, MN (US); Indrani Pal, Minneapolis, MN (US); Liang Meng, Minneapolis, MN (US); Paul Panichelli, Minneapolis, MN (US)

(21) Appl. No.: 19/047,643

(22) Filed: Feb. 7, 2025

(51) Int. Cl. G06N 5/045; G06N 5/01

(52) U.S. Cl. CPC G06N 5/045; G06N 5/01

(57) ABSTRACT

A method for generating explanations for an outcome probability metric, comprising: maintaining a data record comprising a plurality of data entries; training a regression tree for each segment of plurality of segments to model a segment baseline score as a function of spitters features, wherein the segment baseline score is indicative of an expected baseline contribution to a data entry's outcome probability metric based on the associated segment membership; and generating segment explanations for each of the data entries via the trained regression tree, wherein the segment explanations provide the contribution of splitter features to the segment baseline score assignment for the particular data entry, wherein the segment explanations vary across data entries within a segment.

### TECHNICAL FIELD

The subject matter described herein relates to machine learning-based explainability systems, specifically systems and methods for generating categorical explanations in segmented predictive models.

### BACKGROUND

Machine learning is widely used to generate predictions for a variety of applications, such as assessing disease risk, financial decision-making, and behavioral modeling. While these models can achieve high accuracy, they often lack interpretability, making it difficult to explain why a particular prediction was made. In many use cases, such as healthcare, finance, autopilot, cybersecurity, robotics and risk management, it is essential not only to generate accurate predictions but also to provide clear, actionable explanations for stakeholders, including individuals, regulators, and decision-makers.

There is an inherent tradeoff between model accuracy and interpretability. Traditional models like linear regression or GAMs offer transparency but may lack the predictive power of more complex models such as deep learning or ensemble methods. One approach to balancing accuracy and interpretability is segmented modeling, where a population is divided into more homogeneous subgroups, and specialized models are applied within each subgroup. While this approach enhances predictive performance and allows for localized explanations, it introduces a new challenge: explaining both within-group predictions and the impact of group assignment on the final outcome.

Moreover, raw feature contributions may be too detailed for non-technical audiences and may expose proprietary model details, making it necessary to aggregate and simplify explanations into meaningful behavioral categories. Existing explanation techniques often fail to provide a structured, easily interpretable summary while maintaining technical rigor and, in some circumstances, protecting intellectual property. Thus, there is a need for a solution that can generate complete and structured explanations.

### SUMMARY

Methods, systems, and articles of manufacture, including computer program products, are provided for generating explanations for an outcome probability metric. The method comprises maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments; training a regression tree for each segment of plurality of segments to model a segment baseline score as a function of spitters features, wherein the segment baseline score is indicative of an expected baseline contribution to a data entry's outcome probability metric based on the associated segment membership; and generating segment explanations for each of the data entries via the trained regression tree, wherein the segment explanations provide the contribution of splitter features to the segment baseline score assignment for the particular data entry, wherein the segment explanations vary across data entries within a segment.

In some variations, the method further comprises for the predictive features associated with each data entry, generating predictive feature contributions to the outcome probability metric associated with the data entry; project predictive feature contributions and splitter feature contributions into a predetermined set of categories; and generating categorized explanations based on the feature contributions within a category, wherein the categorized explanations are indicative of relative impact of each category on the outcome probability metric, and wherein each of the categorized explanations is associated with a corresponding metric, and wherein the corresponding metrics sum up to the outcome probability metric.

In another aspect, there is provided a computer program product including a non-transitory computer readable medium storing instructions that, when executed by at least one programmable processor, cause the at least one programmable processor to perform operations. The operations include maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments; training a regression tree for each segment of plurality of segments to model a segment baseline score as a function of spitters features, wherein the segment baseline score is indicative of an expected baseline contribution to a data entry's outcome probability metric based on the associated segment membership; and generating segment explanations for each of the data entries via the trained regression tree, wherein the segment explanations provide the contribution of splitter features to the segment baseline score assignment for the particular data entry, wherein the segment explanations vary across data entries within a segment.

In another aspect, there is provided a system comprising: a programmable processor; and a non-transient machine-readable medium storing instructions that, when executed by the processor, cause the at least one programmable processor to perform operations. The operations include maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments; training a regression tree for each segment of plurality of segments to model a segment baseline score as a function of spitters features, wherein the segment baseline score is indicative of an expected baseline contribution to a data entry's outcome probability metric based on the associated segment membership; and generating segment explanations for each of the data entries via the trained regression tree, wherein the segment explanations provide the contribution of splitter features to the segment baseline score assignment for the particular data entry, wherein the segment explanations vary across data entries within a segment.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary architecture of a cloud-based debugging system, in accordance with one or more embodiments of the current subject matter.

FIG. 2 is a diagram illustrating an exemplary predictive features and splitter features of a segment-based model predictive system, in accordance with one or more embodiments of the current subject matter.

FIG. 3 is a diagram illustrating an exemplary utilizing predictive features and splitter features of a segment-based model predictive system to generate an outcome probability metric, in accordance with one or more embodiments of the current subject matter.

FIG. 4 is a diagram illustrating a regression tree serves as a structured representation of the relationship between splitter features and Segment Baseline Score (SBS) values, with each path through the tree reflecting specific decision rules based on splitter feature values.

FIG. 5 is a diagram illustrating a flowchart of a process 500 for generating explanations for an outcome probability metric in a segment-based model, in accordance with one or more embodiments of the current subject matter.

FIG. 6 is a diagram illustrating a flowchart of a process 600 for generating categorized explanations based on predictive feature contributions and splitter feature contributions, in accordance with one or more embodiments of the current subject matter.

FIG. 7 is a diagram illustrating category-level explanations for two data entries, each represented as a pie chart with the same prediction metric, in accordance with one or more embodiments of the current subject matter.

FIG. 8 is a diagram illustrating a comparative visualization of category scores for a single data entry, compared to the category score distribution based on a larger data set, in accordance with one or more embodiments of the current subject matter.

FIG. 9 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed above, there is a need for a solution that can generate complete and structured explanations for segment-based models by decomposing predictions into both segment-based and feature-based contributions, aiding individuals to understand not only their specific prediction but also how their segment assignment influenced the outcome. At the same time, the solution takes into considering regarding protecting proprietary model details while maintaining transparency for various stakeholders, balancing the need for interpretability with intellectual property protection. Additionally, it should aggregate granular feature contributions into meaningful category-level explanations, making the results more interpretable and actionable for decision-making, consumer engagement, and deeper analytical insights. In some instances, these explanations can be used for model debugging, refinement, and optimization. By analyzing the feature and segment-based contributions, data scientists and model developers can identify biases, inconsistencies, or unintended effects in the model's decision-making process. For example, if a particular segment consistently receives disproportionately high or low scores due to an over-weighted feature, developers can fine-tune the feature weighting or adjust the segmentation logic to improve fairness and accuracy. Additionally, explainability can facilitate error diagnostics, allowing model validators to trace misclassifications or unexpected results back to their root causes, making the overall machine learning pipeline more robust and trustworthy.

On the other hand, end users such as model builders, robotics trainers, financial institutions, and service providers can leverage categorical explanations to filter and analyze target customer groups based on their categorical contributions. For example, in robotics training, identifying categories that contribute most to task success probabilities can help refine training data, adjust robotic configurations, or improve environmental conditions to enhance performance. Similarly, service providers can use these explanations to develop targeted interventions or optimize resource allocation. This approach supports precise decision-making and enhances operational efficiency through actionable insights.

Recognizing the limitations of existing systems as described above, the present disclosure provides systems and methods that address these challenges by introducing a structured approach to decomposing predictions (i.e., outcome probability metric) into segment-based and feature-based contributions. This approach allows users to understand not only why a particular outcome was assigned but also how different factors influenced the decision, enabling better model refinement, debugging, and application-specific optimizations.

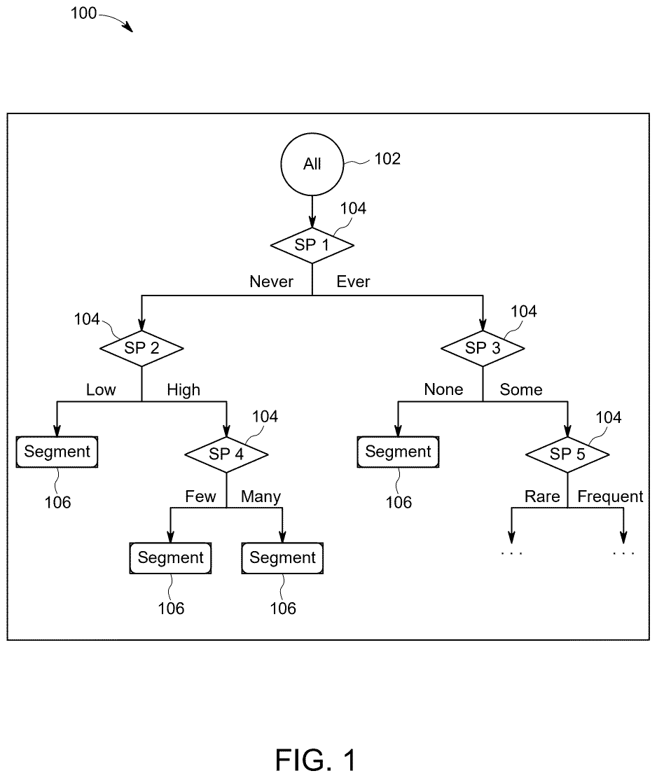

FIG. 1 is a diagram illustrating an exemplary architecture of a segment-based model 100, in accordance with one or more embodiments of the current subject matter. As shown in FIG. 1, a data record 102 may be provided to the segment-based model 100, wherein the segment-based model 100 may operates on a plurality of splitter features (SP) 104, as denoted by SP1, SP2, SP3, etc. The data record 102 may comprise a plurality of data entries. In some embodiments, the splitter features are attributes used to assign a data entry to a specific segment within a segment-based model. These splitter features define segment membership by capturing key characteristics that differentiate subpopulations for one or more segments 106, allowing the model to apply specialized predictive models within each segment 106. The data record may comprise values associated with splitter features, and may thereby be assigned to one of the segments 106 for further processing. After processing, the data record may further include an outcome probability metric, and/or a segment membership, wherein the outcome probability metric is generated by the segment-based model based on the data record, and the segment membership is assigned to the data entries based on the values associated with the splitter features for the data entry.

This segment-based architecture is useful when dealing with heterogeneous populations where different subgroups exhibit distinct characteristics that influence predictive outcomes. For example, in biotech applications, patient populations may vary significantly based on genetic markers, inflammation levels, or clinical history, requiring different predictive models to assess disease progression or treatment response accurately. Similarly, in robotics and industrial automation, operational conditions such as task complexity, environmental stability, and object properties necessitate the use of different control strategies for optimal performance. By segmenting data entries based on relevant features (e.g., splitter features), this architecture allows for the application of specialized models tailored to each subgroup, improving the relevance and accuracy of predictions in diverse real-world scenarios.

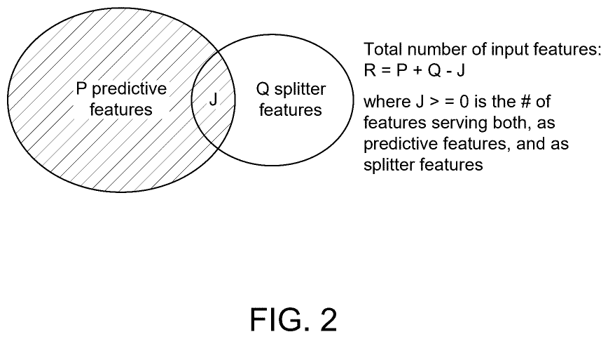

FIG. 2 is a diagram illustrating an exemplary predictive features and splitter features of a segment-based model predictive system, in accordance with one or more embodiments of the current subject matter. As shown in FIG. 2, there may exist P number of predictive features and Q number of splitter features. The predictive features are variables used to generate outcome probability metrics in predictive models that are associated with each of the segments in the segment-based model. These features contribute to determining the final prediction within a given segment by capturing relevant characteristics that influence the outcome, independent of the segmentation process. As shown in FIG. 2, the total number of input features R accounts for both predictive features and splitter features while adjusting for any overlap where a feature serves both roles. In some embodiments, a subset of features may influence both segment assignment (splitter features) and prediction within a segment (predictive features). For example, in biotech applications, a biomarker such as inflammation level may determine a patient's risk group (segment) while also contributing to the probability of disease progression within that group. Similarly, in robotics, environmental stability may dictate whether the robot operates in precision mode or high-speed mode (segment membership) while also influencing the expected success rate of the task execution. By explicitly considering the overlap between predictive and splitter features, this formulation enables more flexible and adaptive modeling while reducing redundancy in feature processing.

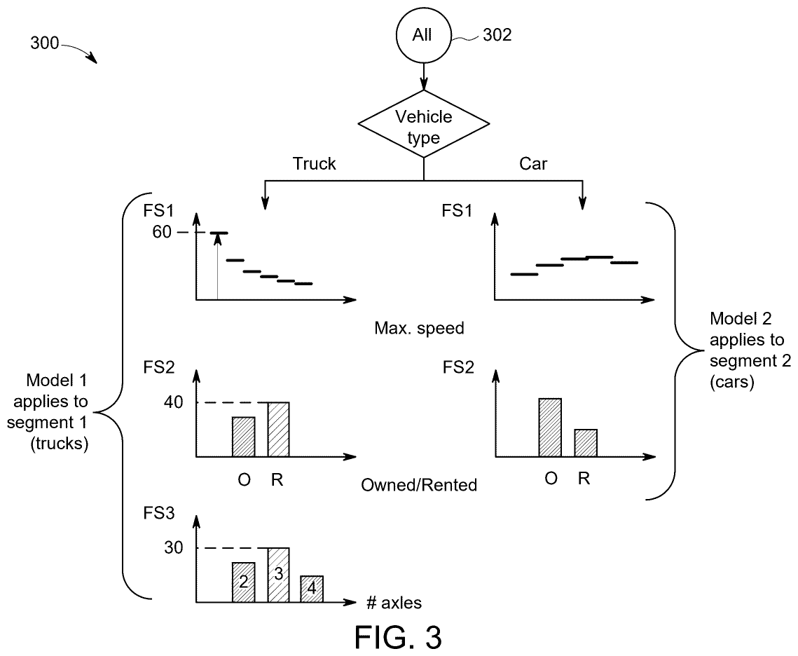

FIG. 3 is a diagram illustrating an exemplary utilizing predictive features and splitter features of a segment-based model predictive system to generate an outcome probability metric, in accordance with one or more embodiments of the current subject matter. The embodiment illustrated by FIG. 3 represents a simplistic illustration of the segment-based predictive model 300. As shown in FIG. 3, the segment-based predictive model 300 processes a data record 302 containing splitter features and predictive features to assign a segment membership and generate an outcome probability metric. In this example, the splitter feature is vehicle type, which categorizes the data entries into two segments: trucks (Segment 1) and cars (Segment 2). Based on the assigned segment, the corresponding predictive model, in this embodiment, a generalized additive model (GAM), is applied.

Each predictive model uses three predictive features (X1, X2, X3) to compute feature scores (FS1, FS2, FS3), which contribute to the final outcome probability metric. For a specific example, a data entry representing a 3-axle rental truck with low maximum speed is assigned to Segment 1 (trucks) based on the value of the splitter feature, vehicle type. The feature scores for this entry are as follows:
FS1 (maximum speed): Contributes a score of 60.
FS2 (ownership type): Contributes a score of 40 for rented vehicles.
FS3 (number of axles): Contributes a score of 30 for 3 axles.

The final outcome probability metric for this entry is the sum of the predictive feature scores, calculated as 60+40+30=130. As shown herein, the predictive features may vary across segments, and not all predictive features are applicable in every segment. For example, as shown in FIG. 3, for the segment representing cars, the predictive features include maximum speed (FS1) and ownership type (FS2), but do not include number of axles (FS3), which is only applicable to the segment representing trucks. This architecture allows the segment-based model to adapt to the specific characteristics of each segment, using specialized predictive models to generate more accurate predictions for the assigned data entries.

As discussed herein, explanations for a segment-based model are desired to aid in improving transparency, supporting debugging and refinement of the model, and fostering trust among stakeholders by providing insights into how predictions are made. These explanations are particularly important in applications where decisions impact individuals or systems directly, such as in medical diagnostics, robotics training, or financial decision-making. When generating contributions of splitter features to segment membership, it is important to balance interpretability with the need to protect proprietary segmentation logic. While the segmentation process relies on specific splitter features to assign data entries to segments, disclosing the exact features or thresholds could expose sensitive details about the segmentation scheme. To address this, the system provides high-level explanations that focus on the impact of splitter features without revealing their precise mechanics, ensuring that stakeholders can understand the segmentation process while preserving the confidentiality of the model's underlying structure.

To address the challenges of providing comprehensive explanations for segment-based models, the present subject matter provides an approach for breaking down predictions into contributions from both splitter features and predictive features. In order to provide meaningful and interpretable explanations for individual scores, it is necessary to attribute such scores to predictive features and splitter features in a structured and transparent manner. While this process is relatively straightforward for standalone predictive models, for example, generalized additive models (GAMs) when there are only predictive features and no splitter features present, it becomes more complex in the context of segmented predictive models. Segmentation introduces flexibility by enabling the modeling of higher-order interactions between predictive features and splitter features, wherein the contribution of any one feature to the final score may vary depending on the values of other features. To address this challenge, the present disclosure describes a modular approach that incorporates score decomposition and the use of a Shapley-based explanation algorithm, allowing for the attribution of feature contributions to the probability metric (aka score) in a segmented model framework.

A data entry assigned to a specific segment is processed using the predictive model associated with that segment. Let FSₚ; p=1, . . . , P denote the feature scores generated by the predictive model, which collectively determine the score for the data entry. Additionally, let BFSₚ denote baseline feature scores which serve as a reference point for explanations. These baselines may be defined as feature score minima, means, or maxima. The score for the data entry can be decomposed into additive components for explanation purposes, where the contribution from each feature is expressed as contributions DFSₚ=FSₚ−BFSₚ, alongside a contribution from the Segment Baseline Score (SBS).

$$Score = {\sum }_{p = 1}^{P} {FS}_{p} = {\sum }_{p = 1}^{P} ( {FS}_{p} - {BFS}_{p} ) + {\sum }_{p = 1}^{P} {BFS}_{p} = {\sum }_{p = 1}^{P} {DFS}_{p} + SBS \qquad ( 1 )$$

The Segment Baseline Score (SBS), represented as

$$S B S = {\sum }_{p = 1}^{P} B F {S}_{p}$$

is derived from the baseline feature scores associated with the applicable segment-level predictive model and is directly tied to the segment membership of the data entry. By taking the expectation of the feature scores over the segment, and setting the baseline feature scores as the mean feature scores, i.e., BFSₚ=E[FSₚ], the SBS becomes the mean score for all data entries within that segment. To explain the contribution of the SBS to a specific data entry, it is necessary to provide context regarding the segment membership. However, directly disclosing detailed segment definitions may present challenges due to the complexity of the segmentation logic and the need to protect proprietary information. Overly detailed descriptions of segments could lead to difficulties in explanation delivery and potential exposure of sensitive segmentation methodologies.

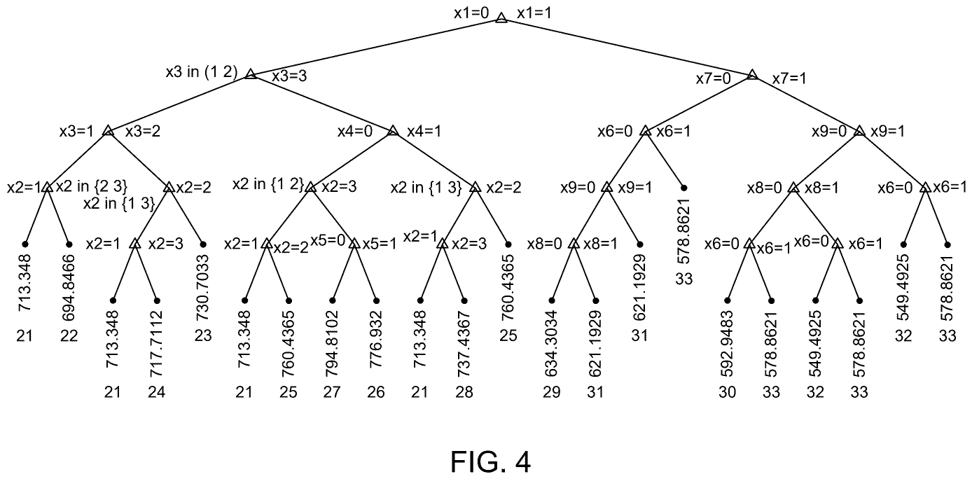

This challenge is addressed by modeling the Segment Baseline Score (SBS) as a function of splitter features and training a regression tree to predict SBS values. As shown in FIG. 4, the regression tree assigns SBS predictions to leaf nodes, where each leaf represents a specific segment classification and is associated with an AlgoID (ranging from 21-33). The predicted SBS values are expressed as numerical values with decimal places, corresponding to segment mean scores. While the segmentation rules can be predefined and manually encoded, an alternative approach involves training a regression model to learn the relationship between SBS and splitter features. In some implementations, a regression tree may be fitted using a training dataset where segment memberships and their corresponding SBS values serve as labels (prediction targets). To improve interpretability and computational efficiency, ordinal splitter features may be categorized based on known split values. For instance, in one example, the system utilizes nine splitter features structured to enhance model performance. After training, the regression tree is further analyzed using explainer algorithms. Specifically, an interventional Tree SHAP algorithm may be applied to compute Shapley values, which quantify the contribution of each splitter feature to SBS, quantifying how the feature influences the baseline prediction for data entries assigned to a specific segment. This approach allows for the explanation of SBS assignments while maintaining the confidentiality of the segmentation logic.

This approach enables a detailed understanding of how each splitter feature contributes to the Segment Baseline Score (SBS) without revealing the precise segmentation logic. As shown in FIG. 4, the regression tree serves as a structured representation of the relationship between splitter features and SBS values, with each path through the tree reflecting specific decision rules based on splitter feature values. The application of the Tree SHAP algorithm ensures that the contributions of individual splitter features are quantified in an interpretable manner, allowing stakeholders to analyze the factors driving SBS assignments for different segments. This method balances the need for explanation with the protection of proprietary segmentation rules, facilitating actionable insights while safeguarding intellectual property.

To compute SHAP (i.e., Shapley) values for splitter features using a predictive model, a background dataset is specified as a reference for comparison. The Shapley value of a given splitter feature for a data entry quantifies the contribution of that feature to the deviation of the data entry's predicted outcome probability metric from the average prediction computed over the background dataset. For any given data entry, the sum of the Shapley values across all features corresponds to the total deviation of the predicted outcome probability metric from the background average.

To determine the contribution of splitter features to the Segment Baseline Score (SBS), the background dataset is selected as a representative sample of the broader scorable population. The average prediction across this background dataset, denoted as S̅, serves as an estimate of the grand mean score of the population. The Shapley value SHAP_{q} of splitter feature x_{q}; q=1, . . . , Q quantifies the extent to which the data entry's assigned SBS deviates from S due to the influence of that particular splitter feature. The aggregate sum of all computed Shapley values for the splitter features accounts for the total deviation of the SBS from S̅.

$$S B S = \overline{S} + {\sum }_{q = 1}^{Q} {SHAP}_{q}$$

Inserting this into eq. (1):

$$Score = \overline{S} + {\sum }_{p = 1}^{P} D F {S}_{j} + {\sum }_{q = 1}^{Q} S H A {P}_{q}$$

A data entry's outcome probability metric is thereby explained as the deviation from the background average score, with contributions attributed to both predictive features and splitter features. The contribution from predictive features reflects their direct impact within the assigned segment, while the contribution from splitter features accounts for the influence of segment membership on the outcome probability metric.

Let h=1, . . . , R enumerate the unique features that contribute to the calculation of the outcome probability metric, whether as predictive features or splitter features. The score decomposition can be expressed in a generalized form by defining a generic feature score FSᵣ as:

$$F {S}_{r} = \{ \begin{matrix}{DFS}_{r} if feature r enters score calculations as GAM feature only \\ {SHAP}_{r} if feature r enters score calculation as splitter feature only \\ {DFS}_{r} + {SHAP}_{r} if feature r enters score calculation as both\end{matrix}$$

By representing feature contributions in this manner, the decomposition of the outcome probability metric is structured such that:

$$Score = \overline{S} + {\sum }_{r = 1}^{R} F {S}_{r}$$

As such, the disclosed system provides a structured approach to explaining the contribution of splitter features in a segment-based predictive model. By modeling the Segment Baseline Score (SBS) as a function of splitter features, a regression tree is trained to estimate SBS based on segment membership, ensuring that the influence of segmentation is captured systematically. To maintain interpretability while protecting proprietary segmentation logic, Shapley values (SHAP) are computed for splitter features, quantifying their respective contributions to SBS without exposing the precise segmentation rules.

Further, within each segment, the contribution of predictive features to the final outcome metric is generated so to provide explanations for the model. While individual predictive features provide direct input to the predictive model, their raw contributions may be too granular or complex for interpretation, particularly for non-technical stakeholders. To improve interpretability, predictive feature contributions are projected into a predetermined set of categories, enabling structured explanations that highlight the relative impact of different feature groups on the outcome probability metric. Similarly, splitter features' raw contributions may be too granular for interpretation and can also benefit from categorization process. This categorization process provides a higher-level summary of how various aspects of a data entry influence the final prediction, facilitating more intuitive insights while preserving the integrity of the underlying predictive model.

To improve interpretability, predictive feature contributions, as well as splitter feature contributions, are projected into a predetermined set of categories, enabling structured explanations that highlight the relative impact of different feature groups on the outcome probability metric. This categorization process provides a higher-level summary of how various aspects of a data entry influence the final prediction, facilitating more intuitive insights while preserving the integrity of the underlying predictive model. This transformation is achieved through category loadings, where each predictive feature contributes proportionally to multiple categories based on predefined weightings.

Let L_{rc}; r=1, . . . . R; c=1, . . . , 5 denote the category loadings for the features such that

$${\sum }_{c = 1}^{5} {l}_{r c} = 1$$

for any given feature, wherein C c=1, . . . , 5 represents the number of predefined categories. The category loadings satisfy the condition:

$${\sum }_{c = 1}^{5} {l}_{r c} = 1$$

for each predictive feature r.

Using these category loadings, the transformation from feature scores (FS) to initial category scores

$$Score = \overline{S} + {\sum }_{r = 1}^{R} F {S}_{r} = \overline{S} + {\sum }_{r = 1}^{R} F {S}_{r} {\sum }_{c = 1}^{5} {l}_{r c} = \overline{S} + {\sum }_{c = 1}^{5} {\sum }_{r = 1}^{R} F {S}_{r} {l}_{r c} = \overline{S} + {\sum }_{c = 1}^{5} {CS}_{c , initial}$$

where

$$C {S}_{c , initial} = {\sum }_{r = 1}^{R} F {S}_{r} {l}_{rc}$$

denote the initial category scores. We call them “initial” because we define “final” category scores, by shifting the initial category scores by certain offset amounts:

$$C {S}_{c} = C {S}_{c , initial} + {offset}_{c}$$

The method requires that the 5 offsets sum up to S̅, so they absorb S̅ into the final category scores such that

$$Score = {\sum }_{c = 1}^{5} C {S}_{c}$$

the offsets are defined as follows:

$${offset}_{c} = \frac{\overline{S} + {\sum }_{c = 1}^{5} min ( C {S}_{c , initial} )}{5} - min ( C {S}_{c , initial} )$$

With this choice, the offsets sum up to S, as required, and the final category scores attain a common minimum:

$$min ( C {S}_{c} ) = \frac{\overline{S} + {\sum }_{c = 1}^{5} min ( C {S}_{c , initial} )}{5}$$

where the right-hand side is a constant independent of c.

This transformation simplifies the interpretation of feature contributions by structuring them into meaningful categories while maintaining mathematical consistency with the original feature score decomposition. Empirical evaluations confirm that the chosen offset values result in category scores that remain non-negative across a broad range of data distributions, enhancing usability and clarity in explanation outputs. Depending on the scale of the predicted probability metric, in some cases, all category scores can be adjusted to remain non-negative, further facilitating interpretation and improving stakeholder comprehension.

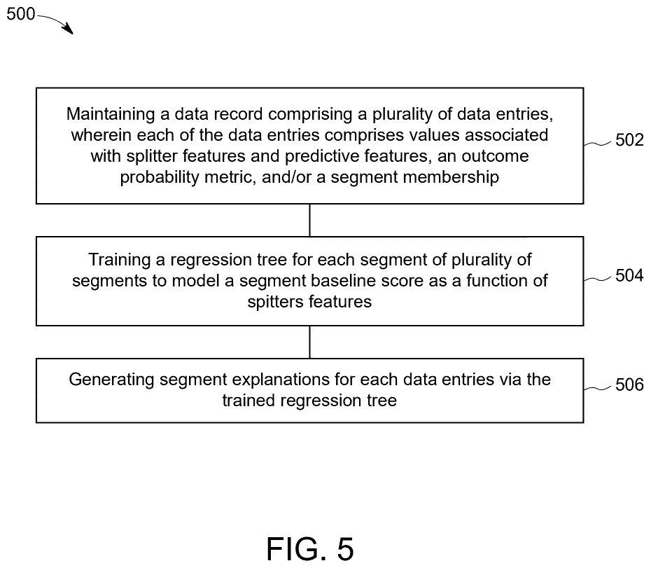

FIG. 5 is a diagram illustrating a flowchart of a process 500 for generating explanations for an outcome probability metric in a segment-based model, in accordance with one or more embodiments of the current subject matter. As shown in FIG. 5, the process 500 may begin with operation 502, where the system maintains a data record comprising a plurality of data entries. Each data entry includes values associated with splitter features and predictive features, an outcome probability metric, and/or a segment membership. The outcome probability metric is generated by a segment-based predictive model based on the data record, while the segment membership is assigned based at least in part on the values associated with the splitter features. This segmentation allows the system to divide the plurality of data entries into multiple segments, where each segment is associated with a distinct predictive model to refine outcome probability calculations.

In operation 504, the system trains a regression tree for each segment to model a Segment Baseline Score (SBS) as a function of the splitter features. The regression tree is trained using a subset of data entries within each segment to estimate the expected baseline contribution to the outcome probability metric based on the assigned segment membership. This allows the system to quantify how segmentation influences predictions at the segment level while preserving the flexibility of using different predictive models across segments.

The process continues with operation 506, where the system generates Shapley-based explanations (SHAP explanations) for each data entry based on the trained regression tree. These explanations provide a breakdown of how splitter features contribute to the assignment of the Segment Baseline Score (SBS) for a particular data entry. The SHAP explanations vary across data entries within a segment, allowing for a detailed understanding of how specific splitter feature values impact an individual's SBS, while maintaining the confidentiality of the segmentation logic.

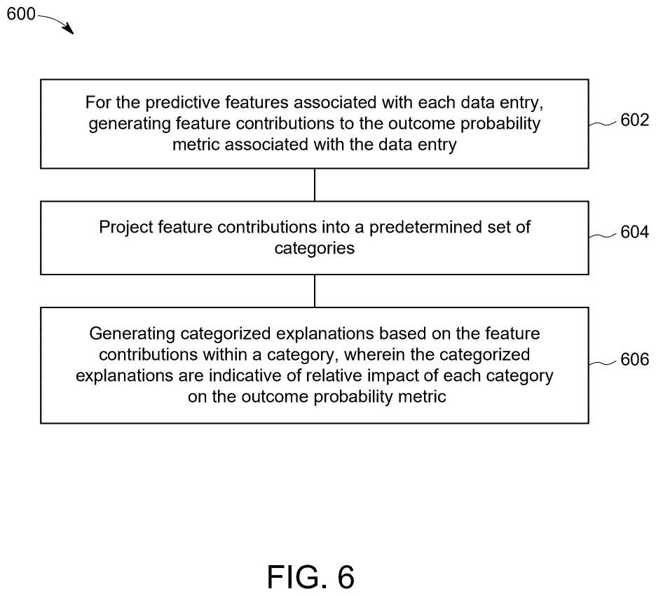

FIG. 6 is a diagram illustrating a flowchart of a process 600 for generating categorized explanations based on predictive feature contributions, in accordance with one or more embodiments of the current subject matter. As shown in FIG. 6, the process 600 may begin with operation 602, where the system determines the feature contributions of predictive features to the outcome probability metric for each data entry. These contributions are derived from the predictive model associated with the segment to which the data entry belongs. Each predictive feature and each splitter feature has an assigned contribution that reflects its impact on the final outcome probability metric, allowing for a granular breakdown of individual feature influence.

In operation 604, the system projects the feature contributions into a predetermined set of categories. Each predictive feature is mapped to one or more predefined categories using category loadings, which define how much each feature contributes to different explanatory groups. This transformation reduces the dimensionality of the feature space, providing a structured and interpretable summary of the primary drivers affecting the outcome probability metric. The process continues with operation 606, where the system generates categorized explanations based on the aggregated feature contributions within each category. The categorized explanations indicate the relative impact of each category on the outcome probability metric, offering a high-level view of how different groups of predictive features contribute to the final prediction. This approach enhances interpretability, making it easier for stakeholders to understand the underlying factors influencing predictions without requiring an in-depth analysis of individual feature contributions. By structuring predictive feature explanations into categories, the system improves transparency and usability while preserving the accuracy and reliability of the predictive model.

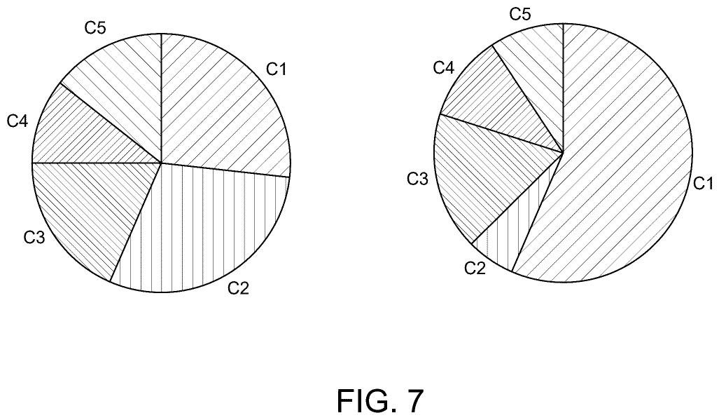

FIG. 7 is a diagram illustrating category-level explanations for two data entries, each represented as a pie chart, in accordance with one or more embodiments of the current subject matter. The pie charts provide an aggregated view of predictive feature contributions grouped into predefined categories, labeled as C1 (Category 1), C2 (Category 2), C3 (Category 3), C4 (Category 4), and C5 (Category 5). Each segment of the pie chart represents the magnitude of contribution from a specific category to the final outcome probability metric. Both data entries (ID1 and ID2) are assigned the same outcome probability metric (score value of 680) but exhibit different distributions of category contributions. For example, in the left pie chart (ID1), C2 (Category 2) is the dominant contributor to the outcome probability metric, followed by C1 (Category 1) and C3 (Category 3). Conversely, in the right pie chart (ID2), C1 (Category 1) is the primary driver, while C2 (Category 2) and C3 (Category 3) contribute less significantly. This figure demonstrates the ability of the system to generate interpretable, category-level explanations that summarize predictive feature contributions, enabling stakeholders to quickly identify the primary factors influencing the outcome probability metric for each data entry. This capability can be particularly useful for tasks such as root cause analysis, model validation, or refining predictive strategies.

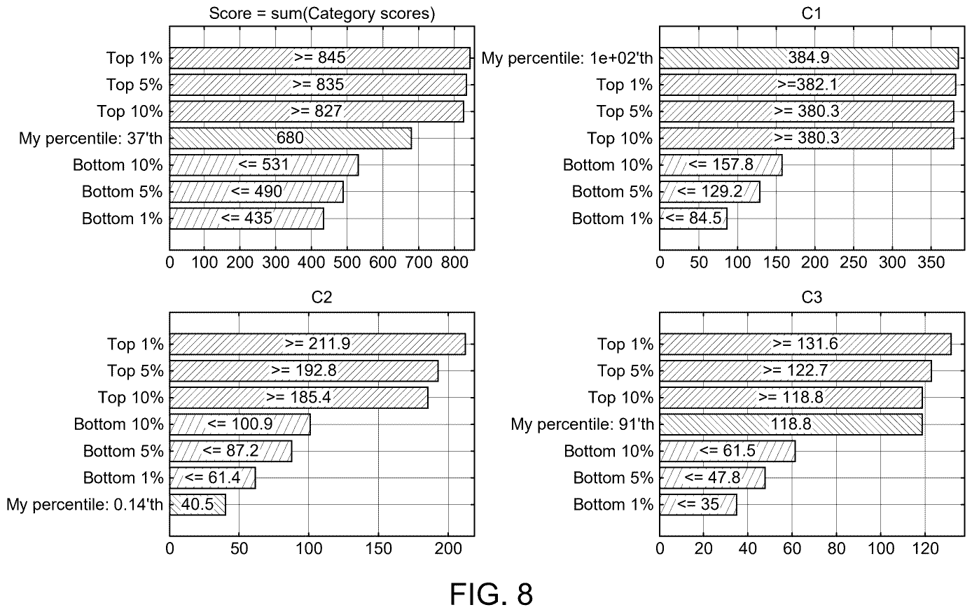

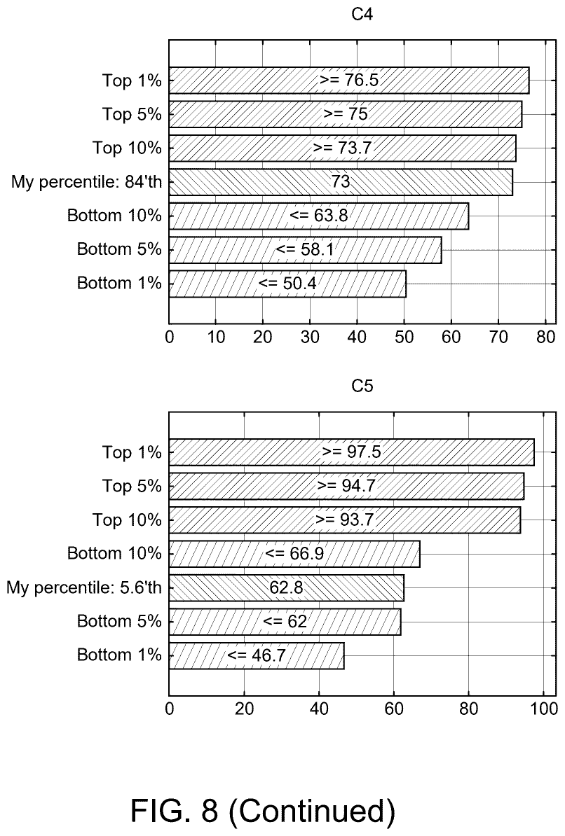

FIG. 8 is a diagram illustrating a comparative visualization of category scores for a single data entry, in accordance with one or more embodiments of the current subject matter. The visualization comprises multiple bar charts, each corresponding to a category (e.g., C1, C2, C3, C4, and C5), where the individual's category score is compared against percentile-based thresholds derived from a reference population.

For each category, the chart displays:
The individual's score within that category (e.g., 384.9 for C1). Percentile thresholds (e.g., Top 1%, Top 5%) that indicate how the individual's score compares to peers in the reference population.
The individual's percentile rank for the category (e.g., 84th percentile for C4).

For instance, the bar chart for C1 demonstrates that the individual's score exceeds the threshold for the Top 5% of the reference population, indicating a strong performance in this category. Conversely, the bar chart for C2 reveals that the individual's score is below the Bottom 1% threshold, suggesting a need for improvement in this category.

This comparative visualization enables stakeholders to gain actionable insights into category-level performance, empowering individuals to focus on specific areas for improvement or optimization while providing a comprehensive understanding of their standing relative to peers. Additionally, the visualization may include interactive elements, allowing users to filter, sort, or drill down into specific categories or percentile groups to explore their performance further. This interactivity enhances the utility of the visualization for data analysis and decision-making.

In some embodiments, the categories may represent specific aspects of performance relevant to the domain. For example, in the context of autonomous driving, the categories could include speed, spatial awareness, braking habits, attentiveness, and compliance with road signs. Each category score provides insights into how well the system performs in these distinct areas, enabling targeted improvements. For instance, a low score in spatial awareness might prompt adjustments to sensor calibration, while a high score in compliance with road signs reinforces effective rule adherence. This categorization ensures that performance metrics are both interpretable and actionable.

In some embodiments, the system may augment the data entries by inserting the categorized explanations and segment explanations as additional columns within the data record. These columns provide structured insights directly tied to the corresponding data entries, enabling seamless integration of the explanation data into downstream analysis workflows. For example, each data entry may include a column summarizing the category-level contributions to the outcome probability metric. In some embodiments, the visualization supports interaction with the augmented data record, allowing users to filter data entries based on segment membership, category-level scores, or the outcome probability metric. For instance, users may apply a filter to identify entries belonging to a specific segment, such as high-risk subpopulations, or focus on entries with dominant contributions from specific categories, such as environmental factors or genetic risk. This interaction facilitates targeted exploration of the data and enables stakeholders to refine strategies based on actionable insights derived from the explanations. The interactive visualization may also support advanced capabilities, such as sorting data entries by category scores or segment contributions, highlighting the highest or lowest contributors within a population. Additionally, users may perform comparative analysis by grouping entries with similar characteristics, enabling deeper exploration of patterns and trends within the data. These features ensure that the visualization is not only informative but also highly functional, promoting data-driven decision-making across various applications.

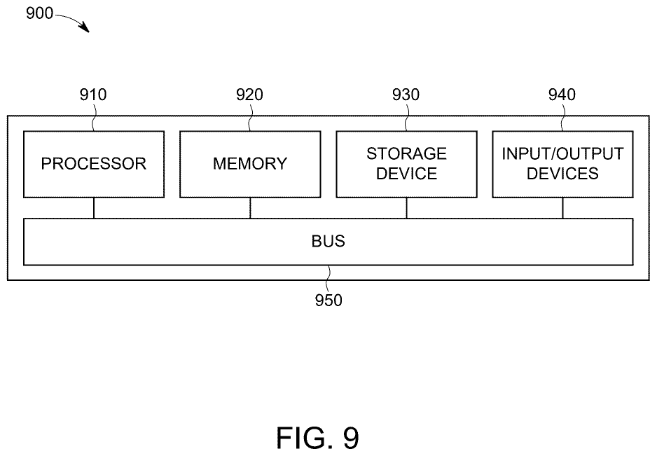

FIG. 9 depicts a block diagram illustrating a computing system 900 consistent with implementations of the current subject matter. As shown in FIG. 9, the computing system 900 can include a processor 910, a memory 920, a storage device 930, and input/output devices 940. The processor 910, the memory 920, the storage device 930, and the input/output devices 940 can be interconnected via a system bus 950. The computing system 900 may additionally or alternatively include a graphic processing unit (GPU), such as for image processing, and/or an associated memory for the GPU. The GPU and/or the associated memory for the GPU may be interconnected via the system bus 950 with the processor 910, the memory 920, the storage device 930, and the input/output devices 940. The memory associated with the GPU may store one or more images described herein, and the GPU may process one or more of the images described herein. The GPU may be coupled to and/or form a part of the processor 910. The processor 910 is capable of processing instructions for execution within the computing system 900. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940.

The memory 920 is a computer-readable medium, such as volatile or non-volatile memory, that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces.

According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

### Use Case 1

In a robotics use case, the described system can be applied to predict the success probability of a robotic task, such as object manipulation or navigation, based on task-specific and environmental data. Each data entry corresponds to an individual task instance and includes values associated with splitter features, such as environmental stability (e.g., degree of surface vibration), task complexity (e.g., number of objects to handle), and robot configuration (e.g., number of active degrees of freedom). These splitter features are used to assign segment membership, dividing tasks into distinct subpopulations, such as high-complexity in unstable environments, moderate-complexity in stable environments, and low-complexity tasks in controlled environments. For example, a segment may consist of tasks performed on uneven surfaces with multiple objects requiring precise manipulation.

After segment membership is determined, a segment-specific predictive model is applied to calculate the outcome probability metric, such as the probability of successful task completion. Predictive features, such as the robot's joint accuracy, actuator performance, and object material properties, are utilized within the segment's predictive model to generate the success probability metric. Each predictive feature contributes to the success probability, with contributions varying based on the segment to which the task instance belongs.

The contributions of predictive features are then mapped into predefined categories, such as robotic configuration, environmental factors, and task complexity. For example, the system might determine that environmental factors contribute 50% to the success probability, task complexity contributes 30%, and robotic configuration contributes 20%. These contributions are aggregated into category-level explanations, showing the relative impact of each category on the outcome probability metric.

This categorized explanation enables engineers to pinpoint areas for improvement. For instance, if the success probability of a task is heavily influenced by environmental instability, measures such as surface stabilization or improved grip mechanisms could be implemented to enhance task performance. Similarly, if task complexity is a significant driver, simplifications in the task sequence or the use of advanced planning algorithms might be prioritized. By structuring explanations into intuitive categories, the system provides actionable insights for improving robotic performance while maintaining transparency about how task and environmental conditions impact the robot's success probability.

### Use Case 2

In a biotech use case, the described system can be applied to predict a patient's disease progression or survival probability using a combination of clinical and genetic data. Each data entry corresponds to an individual patient and includes values associated with splitter features, such as specific genetic mutations (e.g., TP53 mutation status), inflammation levels (e.g., C-reactive protein), and patient demographics (e.g., age). These splitter features are used to assign segment membership, dividing the patient population into distinct subpopulations, such as high-risk, moderate-risk, and low-risk groups, based on shared characteristics. For example, a segment may consist of patients over the age of 60 with elevated inflammation markers and a TP53 mutation.

Once segment membership is determined, a predictive model specific to the assigned segment is used to calculate the outcome probability metric, such as the probability of survival over a five-year period. Predictive features, such as gene expression levels, treatment history, and disease stage, are then used within the segment's predictive model to generate the patient's probability metric. Each predictive feature contributes to the metric, with contributions varying based on the patient's assigned segment.

The contributions of predictive features are then projected into predetermined categories, such as genetic factors, inflammatory markers, and demographic indicators, to provide categorized explanations. For example, the system may determine that genetic risk factors contribute 40% to the survival probability, inflammatory markers contribute 35%, and demographics contribute 25%. These contributions are aggregated into category-level explanations, indicating the relative impact of each category on the predicted outcome.

Such explanations are particularly valuable in guiding clinical decisions, as they allow practitioners to identify key areas of focus for treatment or further diagnostics. For example, if inflammatory markers dominate the category contributions for a high-risk patient, interventions aimed at reducing inflammation could be prioritized. By structuring explanations into categories, the system enables clinicians to interpret complex predictive models in a clear and actionable manner while preserving the integrity of the segmentation process and underlying predictive features.

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for generating explanations for an outcome probability metric, comprising:
maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments;
training a regression tree for each segment of plurality of segments to model a segment baseline score as a function of spitters features, wherein the segment baseline score is indicative of an expected baseline contribution to a data entry's outcome probability metric based on the associated segment membership; and
generating segment explanations for each of the data entries via the trained regression tree, wherein the segment explanations provide the contribution of splitter features to the segment baseline score assignment for the particular data entry, wherein the segment explanations vary across data entries within a segment.

2. The method of claim 1, wherein the method further comprising:
for the predictive features associated with each data entry, generating predictive feature contributions to the outcome probability metric associated with the data entry;
project predictive feature contributions and splitter feature contributions into a predetermined set of categories; and
generating categorized explanations based on the feature contributions within a category, wherein the categorized explanations are indicative of relative impact of each category on the outcome probability metric, and wherein each of the categorized explanations is associated with a corresponding metric, and wherein the corresponding metrics sum up to the outcome probability metric.

3. The method of claim 1, wherein for each data entry, the associated splitter features overlap with a subset of the predictive features.

4. The method of claim 1, wherein each of the predictive models comprises a plurality of predictive features.

5. The method of claim 4, wherein the plurality of predictive features associated with each of the predictive models may vary across different predictive models.

6. The method of claim 4, wherein a plurality of weights associated with the plurality of predictive features vary across different predictive models.

7. The method of claim 2, further comprising:
providing a visualization to present the categorized explanations;
enabling interaction to the visualization by appending the categorized explanations to the data entries as a plurality of additional columns corresponding to the categories; and
wherein the interaction comprises:
selecting a plurality of records of interest, and
comparing and ranking selected data entry's category explanations against the category explanations for the entire data set.

8. A computer program product for generating explanations for an outcome probability metric, the computer program product comprises a non-transient machine-readable medium storing instructions that, when executed by at least one programmable processor, cause the at least one programmable processor to perform operations comprising:
maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments;
training a regression tree for each segment of plurality of segments to model a segment baseline score as a function of spitters features, wherein the segment baseline score is indicative of an expected baseline contribution to a data entry's outcome probability metric based on the associated segment membership; and
generating segment explanations for each of the data entries via the trained regression tree, wherein the segment explanations provide the contribution of splitter features to the segment baseline score assignment for the particular data entry, wherein the segment explanations vary across data entries within a segment.

9. The computer program product of claim 8, wherein the operations further comprises:
for the predictive features associated with each data entry, generating predictive feature contributions to the outcome probability metric associated with the data entry;
project predictive feature contributions and splitter feature contributions into a predetermined set of categories; and
generating categorized explanations based on the feature contributions within a category, wherein the categorized explanations are indicative of relative impact of each category on the outcome probability metric, and wherein each of the categorized explanations is associated with a corresponding metric, and wherein the corresponding metrics sum up to the outcome probability metric.

10. The computer program product of claim 8, wherein for each data entry, the associated splitter features overlap with a subset of the predictive features.

11. The computer program product of claim 8, wherein each of the predictive models comprises a plurality of predictive features.

12. The computer program product of claim 11, wherein the plurality of predictive features associated with each of the predictive models may vary across different predictive models.

13. The computer program product of claim 11, wherein a plurality of weights associated with the plurality of predictive features vary across different predictive models.

14. The computer program product of claim 9, wherein the operations further comprises:
providing a visualization to present the categorized explanations;
enabling interaction to the visualization by appending the categorized explanations to the data entries as a plurality of additional columns corresponding to the categories; and
wherein the interaction comprises:
selecting a plurality of records of interest, and
comparing and ranking selected data entry's category explanations against the category explanations for the entire data set.

15. A system comprising:
at least one programmable processor; and
a non-transient machine-readable medium storing instructions that, when executed by the processor, cause the at least one programmable processor to perform operations comprising:
maintaining a data record comprising a plurality of data entries, wherein each of the data entries comprises values associated with splitter features and predictive features, an outcome probability metric, and/or a segment membership, wherein the outcome probability metric is generated by a segment-based model trained on the data record, wherein the segment membership is assigned to each of the data entries based at least in part on the values associated with the splitter features for the data entry, thereby splitting the plurality of data entries into a plurality of segments, wherein a predictive model is associated with each of the plurality of segments;
training a regression tree for each segment of plurality of segments to model a segment baseline score as a function of spitters features, wherein the segment baseline score is indicative of an expected baseline contribution to a data entry's outcome probability metric based on the associated segment membership; and
generating segment explanations for each of the data entries via the trained regression tree, wherein the segment explanations provide the contribution of splitter features to the segment baseline score assignment for the particular data entry, wherein the segment explanations vary across data entries within a segment.

16. The system of claim 15, wherein the method further comprising:
for the predictive features associated with each data entry, generating predictive feature contributions to the outcome probability metric associated with the data entry;
project predictive feature contributions and splitter feature contributions into a predetermined set of categories; and
generating categorized explanations based on the feature contributions within a category, wherein the categorized explanations are indicative of relative impact of each category on the outcome probability metric, and wherein each of the categorized explanations is associated with a corresponding metric, and wherein the corresponding metrics sum up to the outcome probability metric.

17. The system of claim 15, wherein for each data entry, the associated splitter features overlap with a subset of the predictive features.

18. The system of claim 15, wherein each of the predictive models comprises a plurality of predictive features.

19. The system of claim 18, wherein the plurality of predictive features associated with each of the predictive models may vary across different predictive models.

20. The system of claim 18, wherein a plurality of weights associated with the plurality of predictive features vary across different predictive models.
